(19) United States
(12) Patent Application Publication
(10) Pub. No.: US 2014/0039849 A1
(43) Pub. Date: Feb. 6, 2014

(54) METHOD FOR THE CONSTRUCTION OF A WATER DISTRIBUTION MODEL

(71) Applicant: Amitsur Preis, Singapore (SG)

(72) Inventor: Amitsur Preis, Singapore (SG)

(73) Assignee: Massachusetts Institute of Technology, Cambridge, MA (US)

(21) Appl. No.: 14/112,869

(22) PCT Filed: Apr. 20, 2012
(86) PCT No.: PCT/SG12/00143

§ 371 Date: Oct. 18, 2013

Related U.S. Application Data
(60) Provisional application No. 61/477,241, filed on Apr. 20, 2011.

(51) Int. Cl. G06F 17/50

(52) U.S. Cl. CPC G06F 17/5009
USPC 703/1

(57) ABSTRACT

A method for the determination of demand zones for use with a water distribution model of a water distribution network, the method comprising the steps of: constructing polygons about clusters of consumption nodes; calculating base load consumption of the nodes within each polygon; assigning a consumption type to each polygon, and; aggregating connected polygons of the same consumption type into demand zones.

### FIELD OF THE INVENTION

The Invention relates to the modelling of an urban water distribution system. More specifically the invention relates to the initiation and construction of the model prior to the operation of the system.

### BACKGROUND

Typical urban water distribution systems have complex topology with numerous branches and loops. This composite structure makes the analysis of the system a very difficult task. Therefore, there is a need simplify the distribution network structure by organizing the water consumers in (virtual) demand zones.

### SUMMARY OF INVENTION

In a first aspect the invention provides a method for the determination of demand zones for use with a water distribution model of a water distribution network, the method comprising the steps of: constructing polygons about clusters of consumption nodes; calculating base load consumption of the nodes within each polygon; assigning a consumption type to each polygon, and; aggregating connected polygons of the same consumption type into demand zones

In one embodiment of the present invention, the consumption nodes are grouped based on a multi-criteria demand zones clustering algorithm at which three criteria were used to identify clusters in the water system such that (1) the within-cluster homogeneity of water consumers' characteristics is maximized; (2) the overall variance between total water consumption of the system's clusters is minimized; and optionally (3) the number of connecting links between neighboring clusters is minimized.

Criterion 1 is used to identify areas in the system at which water customers are having similar characteristics (e.g., residential, commercial, or industrial user types) and therefore will not need large adjustments to achieve calibration. To avoid system partition into groups that are too small, comprised of only a few water consumers, a constraint on the lowest total water consumption in each cluster is added.

Criterion 2 is implemented in parallel to criterion 1 to ensure that the clusters are equal in their total base demand and there are no large variations between demand zones' total consumption that can bias decisions.

Additionally Criterion 3 may be used to reduce the number of connections between each demand zone to its neighboring zones as it is often noted that node clusters should be thought of as sets of nodes with more and/or better intra-connections than inter-connections. When interested in detecting communities and evaluating their quality, it is preferred to maximize the number of sets that are densely linked inside and sparsely linked to the outside.

This multi-criteria problem may be solved using graph search algorithms. For instance Breadth-First search and Best First Search and evolutionary optimization approach which partitions the system into homogeneous demand zones (e.g., residential, commercial, industrial) with equal total base demand, and with minimized number of links between them. As often occurs in this type of multi-objective problems, there is no one optimal solution that satisfies all three criteria at the same time and it is anticipated that the three objectives will mutually compete. Therefore, in several cases it will be impossible to find homogeneous demand zones that also comply with the other criteria, and in those cases, the zones will be categorized as mixed clusters (e.g., mixed residential-commercial or mixed commercial-industrial).

Advantages provided by the invention may include:

a) Effectiveness in Hydraulic Model Calibration Procedures:

There are thousands of water consumers with unknown variations in their demand patterns to be estimated in a typical urban water system and only a relatively small number of direct measurements are available. This creates an ill-posed, underdetermined calibration problem which leads to non-unique solutions. This can be overcome by grouping the unknown parameters. Grouping is based on identifying areas of the system at which water customers are having the same characteristics (e.g., residential, commercial, or industrial consumption patterns) and therefore will not need large adjustments to achieve calibration. The main advantage of ‘grouping’ is that the size of the problem is reduced—making it possible to find unique solutions to the optimization problem.

b) Effectiveness in Leakage Detection and Pressure Management:

In the UK, district metered areas (DMAs) have been proven to be effective in leakage monitoring and control. The water networks are divided into District Metering Areas (DMAs) which facilitate direct identification and management of water losses and enable flow tracking between different clusters with flow meters at the DMAs boundaries. In addition, pressure management and leakage localization can be implemented by pressure monitoring within the DMAs to achieve improved leakage reduction.

c) Effectiveness in Improving Water Security:

Dividing the system into consumption blocks at which all connections between the blocks are known and monitored (e.g., flow rates and water quality parameters) can improve the response to an event of a large scale contamination incident. Combining knowledge about blocks connectivity with the implementation of appropriate operation response (e.g. valves closure and hydrants opening) for isolation and flushing of the contamination from the water network would limit exposure to harmful contaminants and minimize the extent of pipe that would need to be decontaminated.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1 is a plan view of an urban water distribution network;

FIG. 2 is a plan view of a skeleton of the urban water distribution network of FIG. 1;

FIG. 3 is a plan view of the urban water distribution network of FIG. 1 having nodes enmeshed by polygons;

FIG. 4 is a connectivity graph according to one embodiment of the present invention; FIG. 5 is a Demand Zone Aggregation according to a further embodiment of the present invention;

FIG. 6 is a plan view of the urban water distribution network of FIG. 1 showing the formed demand zones;

FIGS. 7A to 7C, 8 and 9 are sequential steps of a connectivity minimization process according to a further embodiment of the present invention;

FIG. 10 is a plan view of an urban water distribution network following connectivity minimization according to a further embodiment of the present invention.

### DETAILED DESCRIPTION

The invention provides a method of grouping large numbers of diverse water consumption users to be used in a rational optimization of the water distribution network. Whilst there are a number of procedures for the optimization of such networks dealing with the diversity of users in an urban environment provides a balance between reliable results and managing the needs of said users.

Accordingly, the present invention provides a process to group said users with the following setting out one such method falling within the scope of the invention.

Step 1: Initial Partition Based on the System Main Skeleton

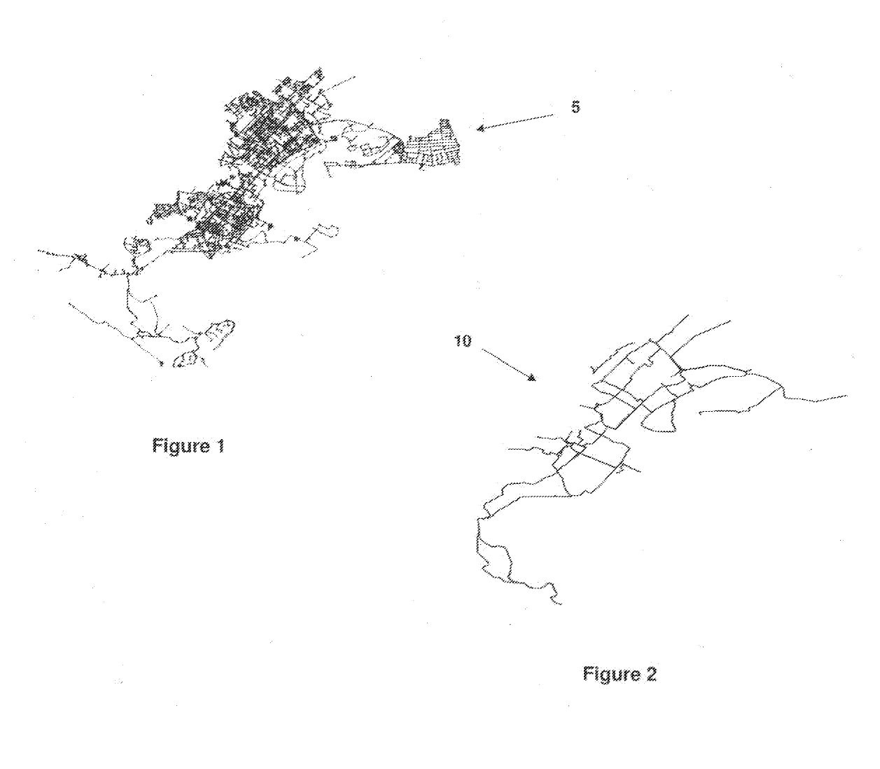

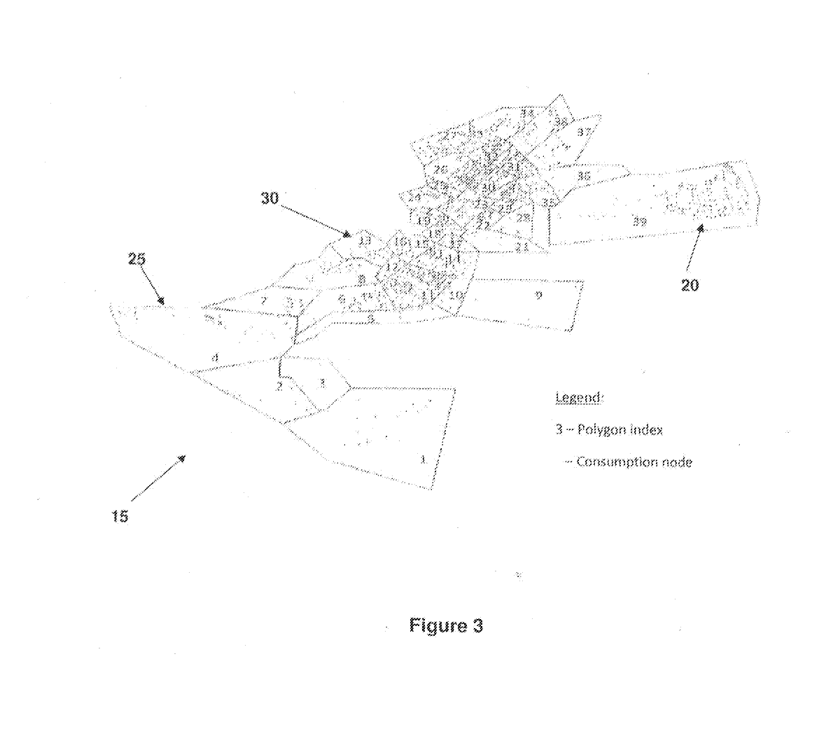

The main skeleton of the system which is comprised of pipes with diameter ≧12″ (304 mm) is used to construct polygons that bind the system consumption nodes. FIG. 1 shows the full water network 5 (with the two service reservoirs, 19415 junctions, and 20072 pipes) and FIG. 2 shows the main skeleton 10 of the system.

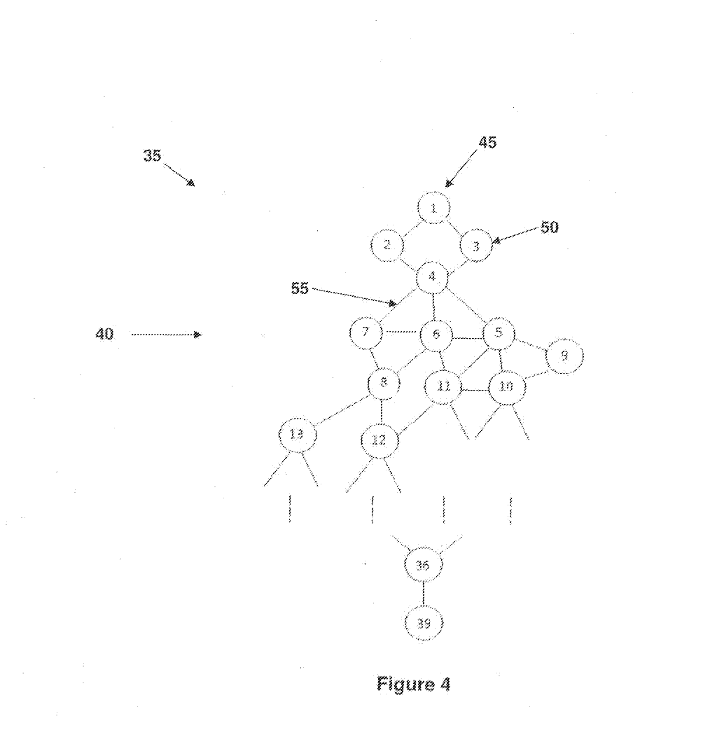

FIG. 3 shows the set of 39 polygons 25 constructed based on the system's main skeleton 15.

All 1717 water consumers 20 (marked in red dotes) in this example network lie inside these polygons 25:

GIS tools can be used for the purpose of constructing polygons out of sets of x, y coordinates and for determining if a point lies on the interior of each polygon. Also it is possible to use one of the known algorithms which are available in the literature for this purpose. In this application, the polygons 25 were constructed out of the main skeleton vertices and demand nodes were assigned to polygons by implementing a procedure for determining if a point lies inside a given polygon.

At the end of this initial step, the total base demand of each polygon is calculated and a consumption type is assigned to each polygon according to the distribution of water consumption 20 within the block (i.e., if more than 60% of the base demand in a block has the same consumption-type then the block is assigned with that consumption type; otherwise the block is assigned with mixed consumption depending on the block components (e.g., mixed residential-commercial, mixed commercial-industrial, and mixed residential-industrial). Table 1 shows these data for the example system:

| | total Base | Resi- | Com- | Indus- | |
|---|---|---|---|---|---|
| Polygon | demand | dential | mercial | trial | |
| index | (CMH) | use (%) | use (%) | use (%) | User type: |
| 1 | 26 | 29.2 | 70.8 | 0.0 | Commercial |
| 2 | 24 | 0.0 | 100.0 | 0.0 | Commercial |
| 3 | 36 | 0.0 | 100.0 | 0.0 | Commercial |
| 4 | 124 | 30.0 | 67.2 | 2.8 | Commercial |
| 5 | 409 | 1.6 | 7.1 | 91.3 | Industrial |
| 6 | 129 | 72.2 | 27.8 | 0.0 | Residential |
| 7 | 74 | 98.0 | 2.0 | 0.0 | Residential |
| 8 | 198 | 26.8 | 72.3 | 0.9 | Commercial |
| 9 | 246 | 0.0 | 0.2 | 99.8 | Industrial |
| 10 | 38 | 7.1 | 30.1 | 62.7 | Industrial |
| 11 | 403 | 26.9 | 70.1 | 2.9 | Commercial |
| 12 | 74 | 89.5 | 10.5 | 0.0 | Residential |
| 13 | 126 | 43.6 | 53.4 | 3.0 | Mixed commercial- |
| | | | | | residential |
| 14 | 354 | 28.7 | 66.0 | 5.3 | Commercial |
| 15 | 80 | 0.0 | 97.9 | 2.1 | Commercial |
| 16 | 11 | 37.9 | 62.1 | 0.0 | Commercial |
| 17 | 63 | 20.4 | 79.6 | 0.0 | Commercial |
| 18 | 50 | 0.0 | 94.4 | 5.6 | Commercial |
| 19 | 22 | 11.2 | 86.6 | 2.2 | Commercial |
| 20 | 1 | 0.0 | 100.0 | 0.0 | Commercial |
| 21 | 158 | 0.0 | 100.0 | 0.0 | Commercial |
| 22 | 228 | 1.3 | 98.7 | 0.0 | Commercial |
| 23 | 273 | 31.7 | 68.3 | 0.0 | Commercial |
| 24 | 62 | 26.7 | 68.0 | 5.2 | Commercial |
| 25 | 24 | 47.3 | 50.8 | 1.9 | Mixed commercial- |
| | | | | | residential |
| 26 | 167 | 45.4 | 53.8 | 0.8 | Mixed commercial- |
| | | | | | residential |
| 27 | 114 | 57.9 | 42.1 | 0.0 | Mixed commercial- |
| | | | | | residential |
| 28 | 154 | 18.6 | 81.4 | 0.0 | Commercial |
| 29 | 117 | 31.6 | 66.4 | 1.9 | Commercial |
| 30 | 127 | 69.9 | 27.2 | 2.9 | Residential |
| 31 | 100 | 61.4 | 35.8 | 2.8 | Residential |
| 32 | 105 | 43.9 | 53.9 | 2.2 | Mixed commercial- |
| | | | | | residential |
| 33 | 22 | 98.9 | 1.1 | 0.0 | Residential |
| 34 | 77 | 86.6 | 10.3 | 3.1 | Residential |
| 35 | 115 | 88.9 | 11.1 | 0.0 | Residential |
| 36 | 3 | 0.0 | 36.4 | 63.6 | Industrial |
| 37 | 64 | 2.4 | 33.3 | 64.3 | Industrial |
| 38 | 210 | 32.2 | 6.0 | 61.8 | Industrial |
| 39 | 323 | 90.5 | 9.1 | 0.4 | Residential |

Step 2: Aggregation of the Network's Nodes Into Demand Zones

In this step, the aim is to group polygons into demand zones which will have equal (as possible) total base demands and homogeneous (as possible) consumption within each group. It is important to create groups of polygons with roughly the same water consumption since having a very large variance between different clusters might bias the system's hydraulic model calibration results.

The process of grouping the basic demand blocks is as follows:

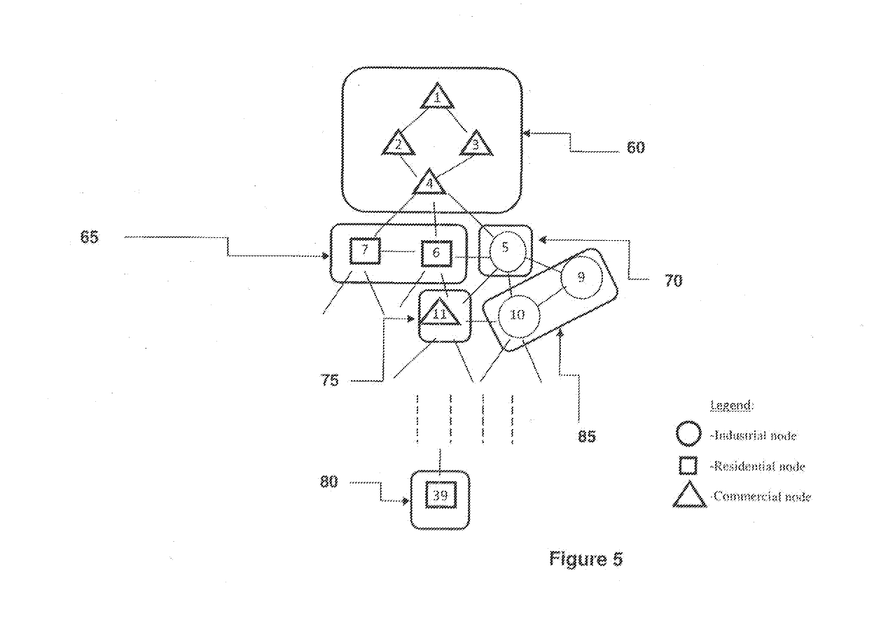

1. The polygons are sorted according to their connectivity and are organized in a graph 35 (FIG. 4) where the graph vertices are the basic blocks 50 and the edges stand for the connectivity 55 between these blocks:

2. Best First Search technique which is a type of graph search algorithm is implemented on the graph presented in FIG. 4 to group the polygons (graph nodes) into equal and homogeneous as possible demand zones: It starts at a root node 45 and exploxes all the nodes which are adjacent to the current node before visiting other nodes. The traversal goes a level at a time 40 and adds a node to a group according to the following preference list sorted from option i which is the best choice to option iii which is the least favorable alternative:
i. Aggregate adjacent nodes with similar consumption type to a group until the total water consumption reaches the maximum consumption threshold (500 CMH)
ii. If the total consumption is below the minimum consumption threshold (200 CMH) then add nodes with mixed consumption (where at least one of the components of the mixed node is similar to the group's consumption type). Stop when the total base demand exceeds the minimum boundary
iii. If the total consumption is below the minimum consumption threshold (200 CMH) and there is no better choice, add any adjacent node with any consumption type until the minimum consumption threshold is met
The 200-500 CMH amplitude allows some flexibility in aggregating the nodes into homogeneous as possible groups while keeping the nodes consumption on the same scale.
FIG. 5 demonstrate the results of above procedure on some of the graph nodes:

In this example, polygons 1, 2, 3 and 4 which have all been designated commercial use are grouped as a first demand zone 60. Similarly, polygons 6 and 7 which are categorized as residential notes are grouped as a second demand zone 65. To demonstrate that demand zones may encompass single polygons as demonstrated by the industrial nodes 5 forming a third demand zone 70, commercial nodes 11 forming a demand zone 75 and resdential nodes 39 forming demand zone 80.

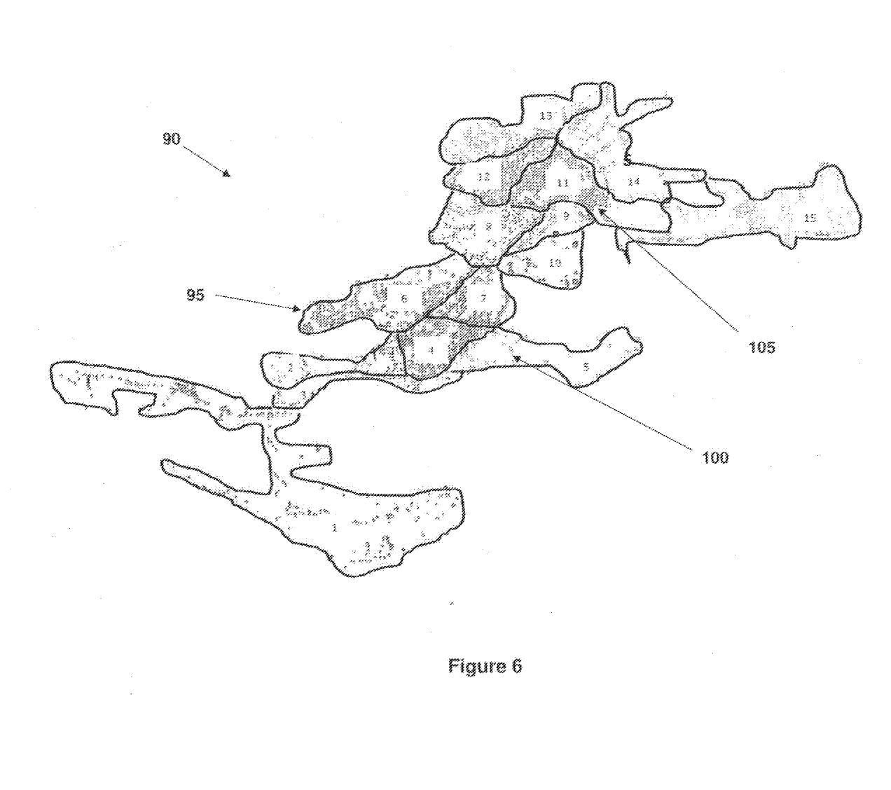

At the end of this procedure, the 39 basic blocks were aggregated into 15 demand zones. Table 2 and FIG. 6 summarize the results of step 2. Therefore the water network 90 is now divided into various demand zones 95 comprising categorized consumers 100, 105 within each demand zone.

TABLE 2
Demand zones details

| Demand | Components | Total base | |
|---|---|---|---|
| zone index | (aggregated polygons) | demand (CMH) | Consumption type |
| 1 | 1, 2, 3, 4 | 209.7 | Commercial |
| 2 | 6, 7 | 202.3 | Residential |
| 3 | 5 | 408.7 | Industrial |
| 4 | 11 | 402.6 | Commercial |
| 5 | 9, 10 | 283.8 | Industrial |
| 6 | 8, 12, 13, 15, 16 | 489.4 | Mixed commercial- |
| | | | residential |
| 7 | 14, 17 | 416.4 | Mixed commercial- |
| | | | residential |
| 8 | 18, 19, 20, 23, 24, 25 | 431.6 | Mixed commercial- |
| | | | residential |
| 9 | 22, 29 | 344.8 | Commercial |
| 10 | 21, 28 | 311.6 | Commercial |
| 11 | 30, 31, 35 | 342.2 | Residential |
| 12 | 26, 32 | 271.3 | Mixed commercial- |
| | | | residential |
| 13 | 27, 33, 34 | 213.5 | Residential |
| 14 | 36, 37, 38 | 276.6 | Industrial |
| 15 | 39 | 323.0 | Residential |

Step 3: Minimizing the number of links between neighboring demand zones

The purpose of this step is to reduce the number of connections between each set and its neighboring sets. This is achieved by solving the following optimization problem for each pair of adjacent demand zones.

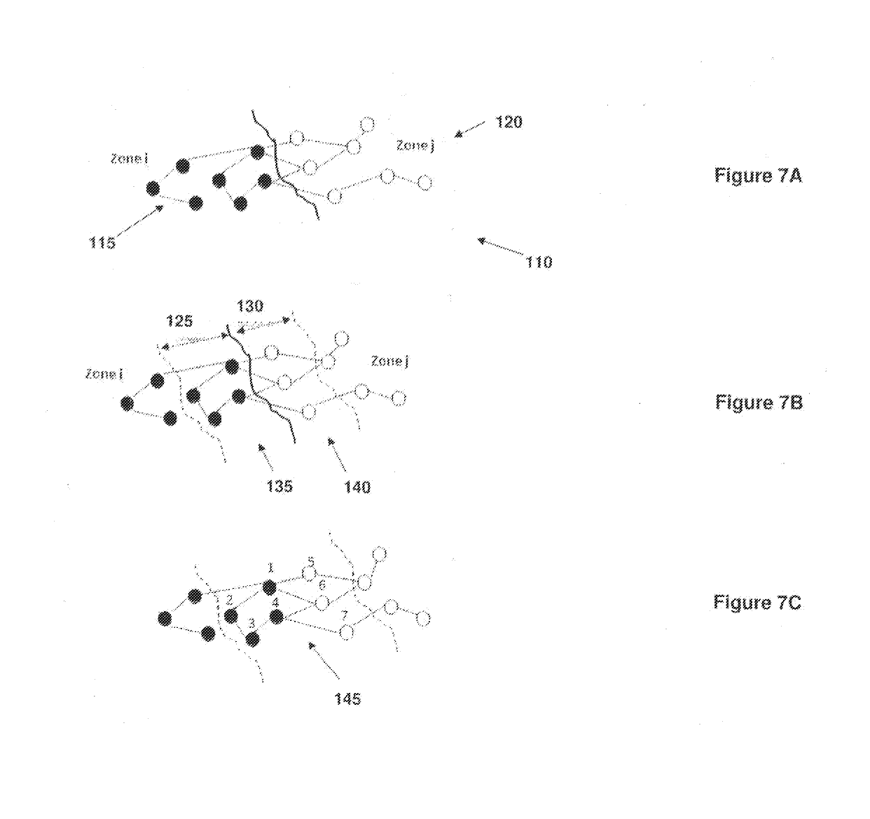

The decision variables of this optimization problem are the water system junctions (with no water consumption) in a range of 500 m 125, 130 from both sides of the border 110 between the two zones 115, 120. All the nodes indexes and the zones that these nodes belong to are written to a matrix. FIGS. 7A to 7C describe this procedure:

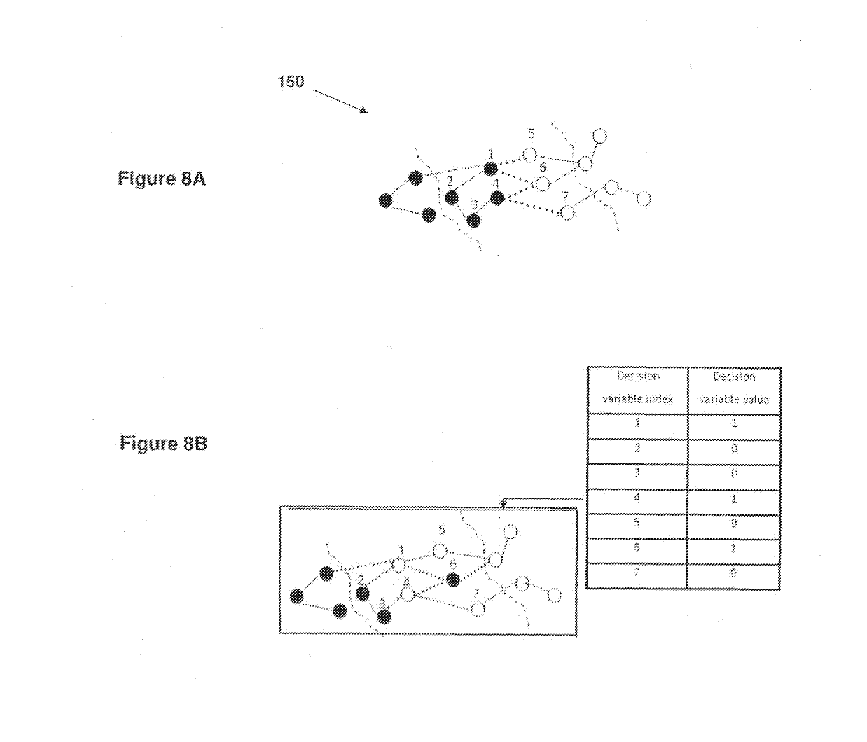

The objective function to be minimized with a Genetic Algorithm procedure is the sum of connections between zones i 115 and j 120. The decision variables values are 0 or 1. If the value equals 1 then the node's zone index is switched from i to j and vice versa. If the value is zero the node remain in its original demand zone. In the illustrative example given below, each decision variables' string is comprised of 7 random Boolean values for the first GA iteration. At the subsequent iterations (using the GA operators) nodes are shifted from zone to zone until the number of connections between the zones is minimized. FIGS. 8A and 8B demonstrate this procedure.

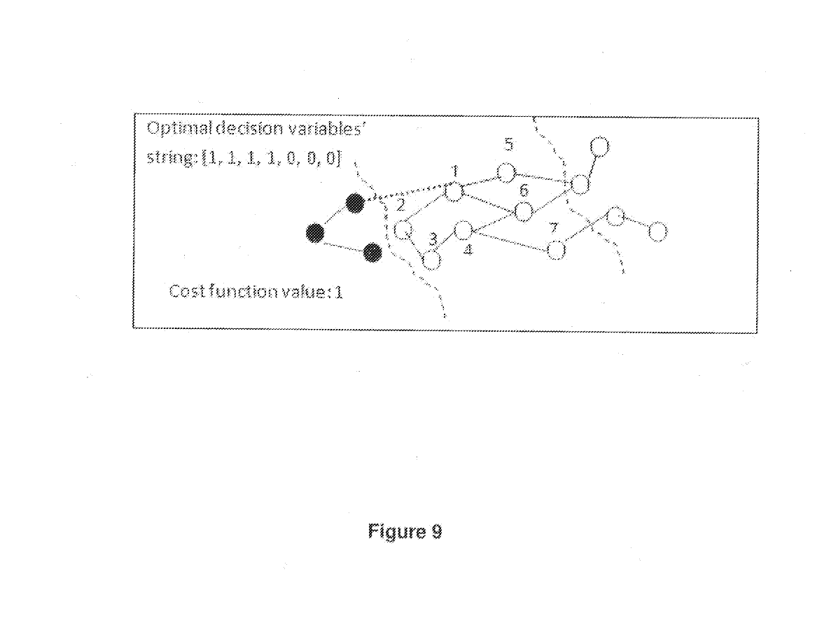

At the end of the GA procedure nodes were switched (or not switched) from zones i and j and as a result the number of connections between the zones is minimized 150. See optimal solution for the illustrative example in FIG. 9:

The results of the implementation of the GA procedure on the FCPH network showed that the average optimal number of connections between each set of two neighboring demand zones is 5 (e.g., the number of connecting pipes for zones 1 and 3 is 2; for zones 3 and 4 its 5; for zones 10 and 11 its 1; and for zones 11 and 12 its 10).

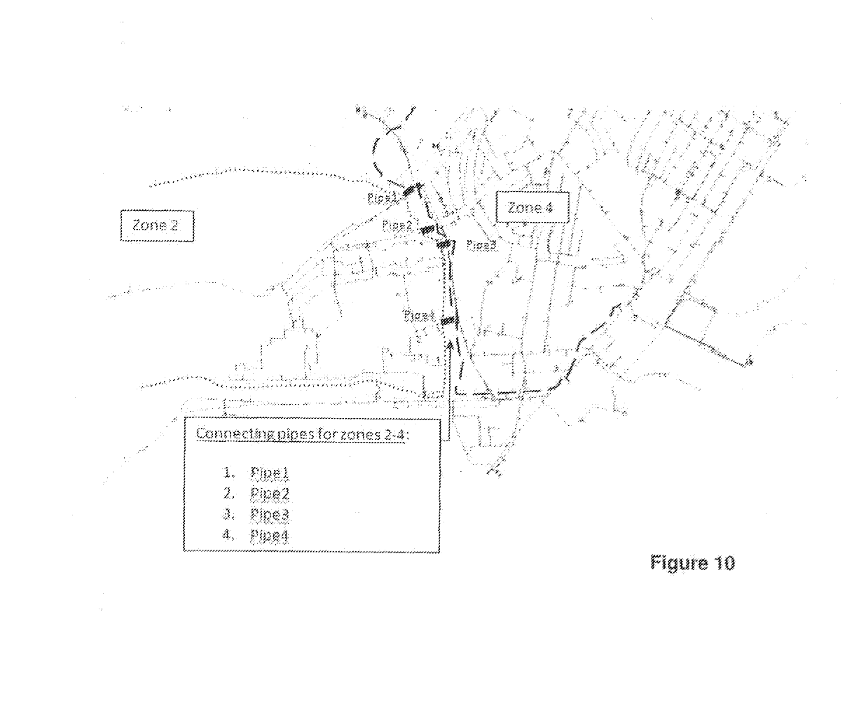

FIG. 10 shows the practical application of the procedure whereby connecting pipes between adjacent zones 2 and 4 are minimized to only 4 pipes. The connection minimization procedure is completed for each of the zonal boundaries throughout the water network.

1. A method for the determination of demand zones for use with a water distribution model of a water distribution network, the method comprising the steps of:
constructing polygons about clusters of consumption nodes;
calculating base load consumption of the nodes within each polygon;
assigning a consumption type to each polygon, and;
aggregating connected polygons of the same consumption type into demand zones

2. The method according to claim 1, wherein the aggregating step includes balancing a uniform total base demand for all demand zones and maintaining a homogenous consumption within each demand zone.

3. The method according to claim 1, wherein the consumption types include residential, industrial and commercial.

4. The method according to claim 1, wherein the consumption types further include mixed consumption types between residential, industrial and commercial type so as to facilitate balancing consumption type within each demand zone and equal total base demand for all demand zone.

5. The method according to claim 1, wherein the assigning step includes determining the consumption type within a polygon based upon a minimum of 60% of said consumption type nodes within said polygon;

6. The method according to claim 5, wherein the mixed consumption type is assigned to a polygon where the maximum proportion of nodes of any one consumption type is less than 60%.

7. The method according to claim 1, wherein the forming step includes aggregating polygons into demand zones based on connectivity.

8. The method according to claim 1, wherein the aggregating step comprises the steps of :
accumulating connected polygons of a similar consumption type, and;
calculating the total water consumption of the aggregated group until the aggregated group has a total water consumption between a minimum and maximum threshold so as to form a homogenous demand zone;
if there are insufficient connected polygons of the same consumption type to meet the minimum threshold type, then;
adding polygons of a different consumption type until the minimum threshold is exceeded, so as to form a mixed consumption demand zone.

9. The method according to claim 1, wherein the minimum threshold is 200 Cubic metres per hour and the maximum threshold is 500 Cubic metres per hour.

10. The method according to claim 1, wherein further including, after the aggregating step, the steps of:
selecting a buffer zone around each demand zone boundary;
identifying respective nodes on each side of the boundary within said buffer zone;
calculating the number of connections between nodes crossing said boundary;
reallocating a buffer node in one demand zone to the adjacent demand zone;
recalculating the number of connections crossing said boundary and compare with the first number of connections;
repeat reallocating and recalculating steps until a minimum number of connections are found;
finalizing demand zones based on reallocation of buffer nodes having the minimum number of connections crossing the boundary.
